(19) United States
(12) Patent Application Publication
(10) Pub. No.: US 2004/0213953 A1
(43) Pub. Date: Oct. 28, 2004

(54) APPARATUS, SYSTEM, AND METHOD OF JOINING STRUCTURAL COMPONENTS WITH A TAPERED TENSION BOND JOINT

(75) Inventors: Jerry W. Brantley, Fort Worth, TX (US); Charles Mark Rodenberger, Fort Worth, TX (US)

Correspondence Address: BRACEWELL & PATTERSON, L.L.P., SUITE 2900, 711 LOUISIANA STREET, HOUSTON, TX, 77002-2781, US

(73) Assignee: Lockheed Martin Corporation

(21) Appl. No.: 10/422,254

(22) Filed: Apr. 24, 2003

(51) Int. Cl. B32B 7/00

(52) U.S. Cl. 428/119; 156/91

(57) ABSTRACT

A system of composite and adhesive materials provides for a high strength, producible closeout joint in the form of tapered tension bond joint for high performance structures. The system includes one skin that is co-bonded to flat panel spars, with the joint being positioned at the opposite side of the spars. The spar includes a female receptacle that receives a male blade from the closeout skin assembly. The flat panel spars have imbedded nut elements in the blade that serve as “internal tooling” to provide a positive stop for locating and clamping the lower skin. The disruption of the blade by the imbedded nuts gives the final assembled structure a very significantly enhanced ballistics survivability. The nuts act to stop cracks formed in the structure when the structure is impacted. A very significant amount of tolerance is allowed between the blade and the receptacle to further reduce cost.

### BACKGROUND OF THE INVENTION

1. Technical Field

The present invention relates in general to an improved joint for structural components, and in particular to an improved apparatus, system, and method for forming a tapered tension bond joint between structural components.

2. Description of the Related Art

Closeout panels can present problems for manufacturers, in that panels may attach to a substructure without access to the backside of the panel. In the past, these panels have been bolted to the substructure or attached using blind fasteners, such as pull rivets. These methods require expensive and time-consuming drilling and fastening operations and may weaken the structure. More recently, these panels have been co-bonded or secondarily bonded using resin or a thin layer of adhesive.

Typically, laminating resins are used as the matrix material in woven textiles, this also being true for woven preforms used to connect components made of composites or other materials. An example of a commonly used laminating resin is 977-3, available from Cytec Industries, Inc., of West Paterson, N.J. The laminating resin is infused into a textile product and is cured to form a polymer matrix in the finished composite component. When assembling a typical joint using a preform, the preform may be co-cured along with uncured composite components or the components may be cured prior to assembly using an uncured preform. Because of the inferior bonding characteristics of laminating resins, a thin layer of adhesive is often placed between the preform and the components. Generally, an adhesive film is used, which is expensive and adds to fabrication time.

To achieve proper bonding when using a thin layer of adhesive, such as an adhesive film, between pre-cured components, special attention must be paid to the interface at the adhesive layer. This bond line is critical, and, where two surfaces are brought together, the distance between the surfaces must be within a critical tolerance to ensure a proper bonding layer. The thickness of the adhesives is usually about 0.015″ thick with a bond layer tolerance of ±0.005″. Methods for ensuring proper bonding may include tools, such as molds or vacuum bags, but particular applications may prevent the use of tools due to the inaccessibility of one or both sides of the joint. An example of this type of application is a closeout panel, such as the skin of a wing being bonded to an internal spar.

Z-pins have been used in joints connecting two composite, laminate components in the prior art. For example, U.S. Pat. Nos. 5,863,635, 5,968,639, and 5,980,665 to Childress discloses inserting z-pins into a first composite component to form stubble at a bonding face, then curing the first component. An uncured second component is then bonded to the first component with the stubble extending into and among the fibers of the second component and through the bond line.

As shown in FIG. 1 and in the '635, '639, and '665 patents, an additional prior-art method includes inserting a padup strip 11 between two cured components 13, 15. Components 13, 15 are generally formed of plies of woven or unidirectional fibers and a resin matrix and are cured with a Z-pin stubble extending from surfaces 17, 19. Padup strip 11, which is typically formed of the same materials as components 13, 15 or formed of a pure adhesive material without fiber reinforcement, is uncured during assembly. Components are assembled with padup strip 11 between surfaces 17, 19, the z-pin stubble fields extending into padup strip 11. The resin in padup strip 11 is then cured to co-bond the components 13, 15 to padup strip 11.

An alternative method of assembly using z-pins is disclosed in U.S. Pat. Nos. 5,876,540, 5,876,832, 5,935,698 to Pannell and is shown in FIG. 2. A pre-cured strip 21 is formed of a plurality of plies of fibers and a resin matrix, a plurality of z-pins 23 extending from opposite sides of strip 21. Components 25,27 are also formed of composites and may be cured or partially cured. To assemble partially cured components 25, 27, strip 21 is positioned between components 25, 27, then z-pins 23 are inserted into adjacent surfaces 29, 31. The resin in components 25, 27 is cured to co-bond surfaces 29, 31 and to retain z-pins 23 within components 25, 27. Alternatively, if components 25,27 are pre-cured, padup strips 33 are used between strip 21 and surfaces 29, 31. Padup strips 33, like padup strip 11 in FIG. 1, are typically formed of the same materials as components 25, 27 or formed of a pure adhesive material without fiber reinforcement.

Several currently pending applications are related to the present invention, these applications disclosing inventions using preforms having fibers in a three-dimensional weave to create structural joints. U.S. patent application Ser. Nos. 09/898,633 and 10/028,613, filed Jul. 2, 2001, and Dec. 21, 2001, respectively, disclose adhesive-infused preforms and methods of joint assembly, the joints lacking z-pin reinforcement. U.S. patent application Ser. No. 09/946,627, filed Aug. 31, 2001, and U.S. patent application Ser. No. 09/973,208, filed Oct. 9, 2001, disclose z-pin reinforced joints and methods of assembly using resin-infused preforms formed from a three-dimensional weave pattern.

A need exists for an improved method that reduces the steps in assembly and provides for a strong joint when joining components using a woven preform. A further need exists for a method of joining components in a structural joint that provides for a larger dimensional tolerance between components when using an adhesive at the bond line.

### SUMMARY OF THE INVENTION

One embodiment of the present invention comprises a tapered tension bond joint that utilizes a system of composite and adhesive materials to provide for a high strength, producible closeout joint for high performance structures. The closeout joint is the last major step in assembling the structure. The system includes one skin that is co-bonded to flat panel, pre-cured spars. The tapered tension bond joint is positioned at the opposite side of the spars to provide the closeout joint. The spar provides a female receptacle or slot that is designed to receive a matching male blade from the closeout skin assembly. The male blade is co-cured with the lower skin. The flat panel spars are designed with a series of imbedded nut elements in the blade that serve as “internal tooling” to provide a positive stop for locating the lower skin, as well as a means for clamping the lower skin to the upper assembly during the closeout operation. The disruption of the blade of the closeout joint by the imbedded nuts gives the final assembled structure a very significantly enhanced ballistics survivability. The nuts act to stop cracks formed in the structure when the structure is impacted. A very significant amount of tolerance is allowed for the fit between the blade and the slot, thereby reducing the cost associated with highly accurate 3-D joints.

The foregoing and other objects and advantages of the present invention will be apparent to those skilled in the art, in view of the following detailed description of the preferred embodiment of the present invention, taken in conjunction with the appended claims and the accompanying drawings.

### BRIEF DESCRIPTION OF THE DRAWINGS

So that the manner in which the features and advantages of the invention, as well as others which will become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is an exploded, perspective view of a prior art assembly using a padup strip and components having z-pin stubble;

FIG. 2 is a front view of a prior art assembly formed using a pre-cured strip to connect components, the pre-cured strip having z-pins extending from opposite sides;

FIG. 3 is a side view of one embodiment of a structure constructed in accordance with the present invention;

FIG. 4 is a sectional end view of the structure of FIG. 3 taken along the line 4-4 of FIG. 3 and is constructed in accordance with the present invention;

FIG. 5 is a sectional end view of the structure of FIG. 3 taken along the line 5-5 of FIG. 3 and is constructed in accordance with the present invention;

FIG. 6 is a sectional end view of the structure of FIG. 3 taken along the line 6-6 of FIG. 3 and is constructed in accordance with the present invention;

FIG. 7 is an exploded side view of the structure of FIG. 3 and is constructed in accordance with the present invention;

FIG. 8 is an exploded end view of the structure of FIG. 3 prior to final assembly and is constructed in accordance with the present invention;

FIG. 9 is an isometric view of a pre-form used to form various portions of the structure of FIG. 3 and is constructed in accordance with the present invention;

FIG. 10 is an isometric view of the pre-form of FIG. 3 that has been configured as a protrusion and is constructed in accordance with the present invention;

FIG. 11 is an isometric view of the pre-form of FIG. 3 that has been configured as a receptacle for a spar web and is constructed in accordance with the present invention.

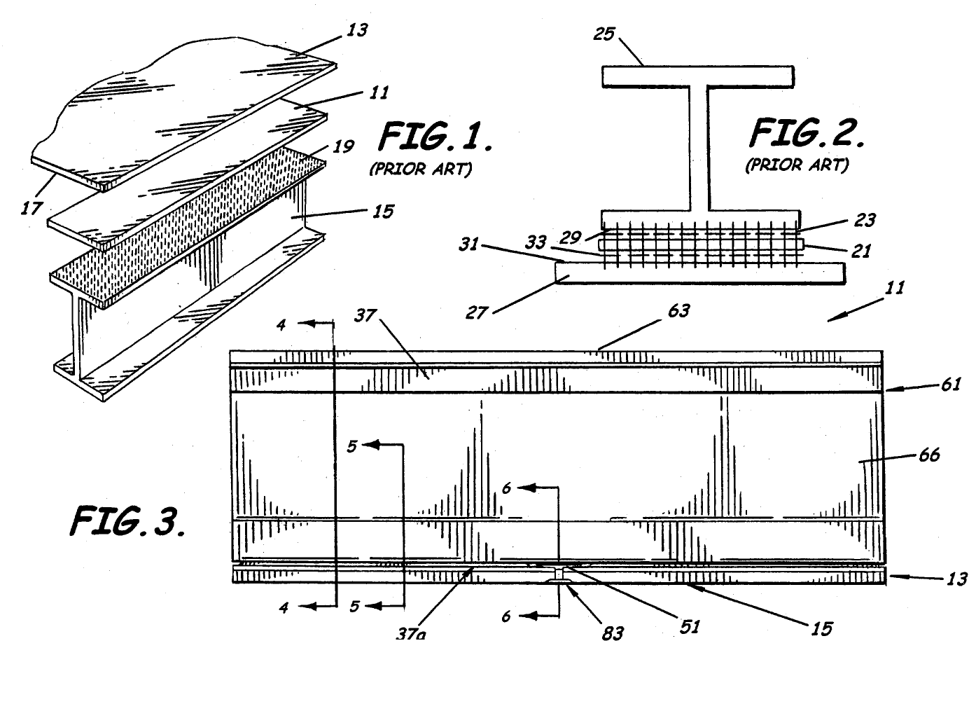

### DETAILED DESCRIPTION OF AN ILLUSTRATIVE EMBODIMENT

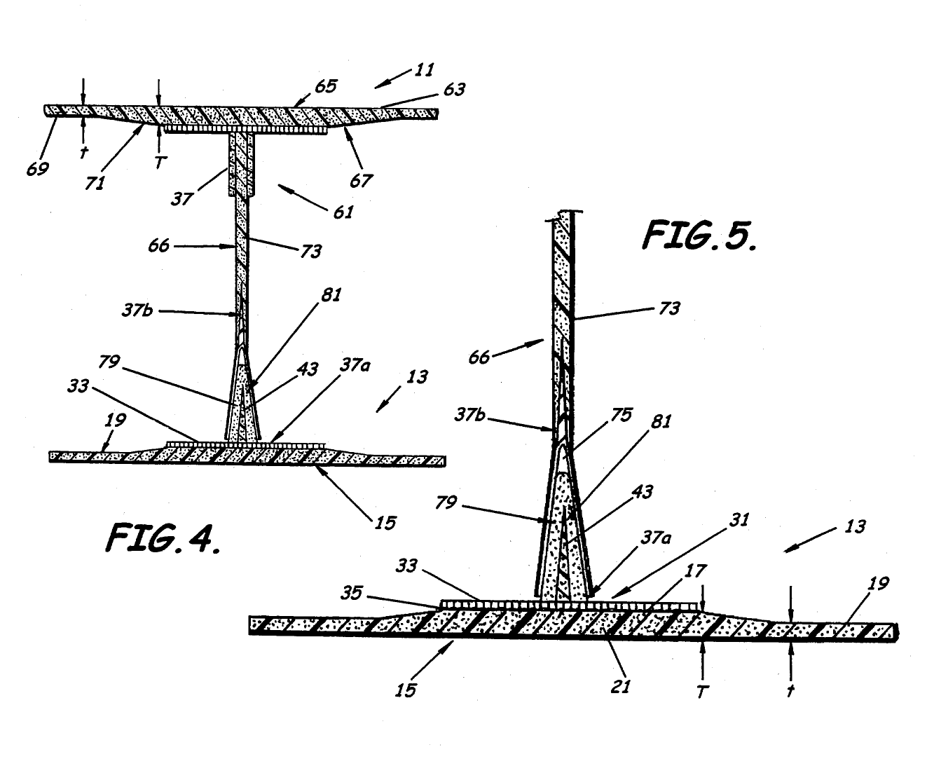

Referring to FIGS. 3 and 4, one embodiment of a structural assembly 11 constructed in accordance with the present invention is shown. In the embodiment shown, the structural assembly 11 includes a joint component, e.g., a closeout assembly 13 (FIG. 5). Closeout assembly 13 has a first structural member comprising an external surface 15 and a plurality of internal joint surfaces 17 located opposite the external surface 15. In one version, the external surface 15 is formed by a “closeout skin” comprising a co-bonded laminated composite. The closeout assembly 13 has nominal regions 19 and each of the internal joint surfaces 17 is located on a built-up region 21. The nominal regions 19 have a thickness “t” that is less than a thickness “T” of the built-up regions 21.

The closeout assembly 13 also includes a plurality of protrusions 31 (one shown in FIG. 5). Each of the protrusions 31 extends from a respective one of the internal joint surfaces 17. The protrusions 31 are joined to the closeout assembly 13 with z-pins 33 extending through respective ones of the built-up regions 21. An adhesive 35 is located between and bonds respective ones of the protrusions 31 and the built-up regions 21.

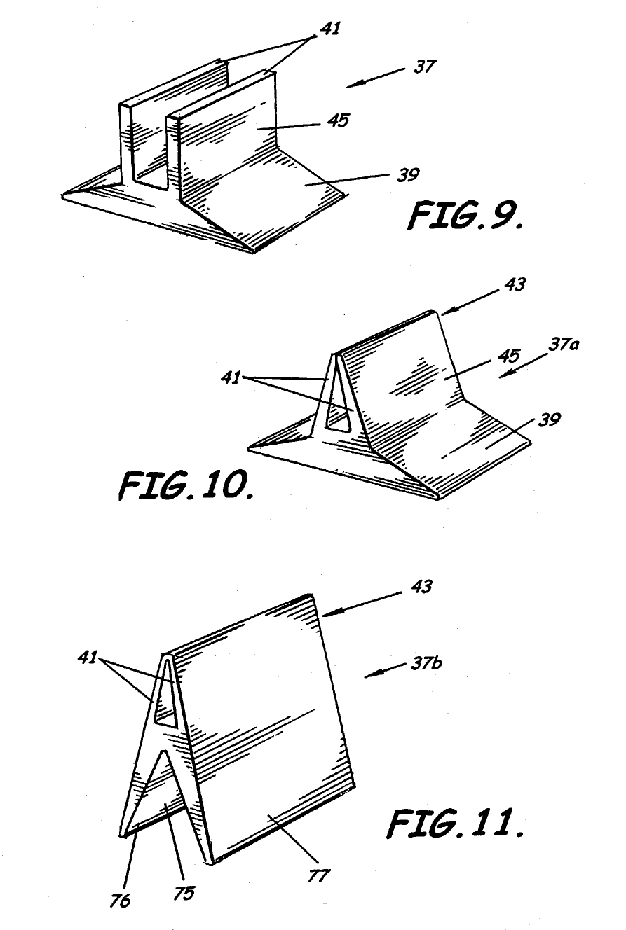

In one embodiment, each protrusion 31 comprises a pi-shaped pre-form 37 (FIG. 9) having a planar base 39 and a pair of legs 41 extending from the base 39. As shown in FIG. 10, the pre-form 37 is deformed into a pre-form 37a, such that the pair of legs 41 are inclined toward each other to form a wedge-like blade 43 having an elongated shape with outer surfaces 45. Pre-form 37a retains a substantially flat base 39. More detailed discussions of pre-forms are found in U.S. patent application Ser. Nos. 09/761,301; 09/973,208; 09/898,633; 09/938,065; and 09/946,627; each of which is assigned to the present assignee and is incorporated herein by reference.

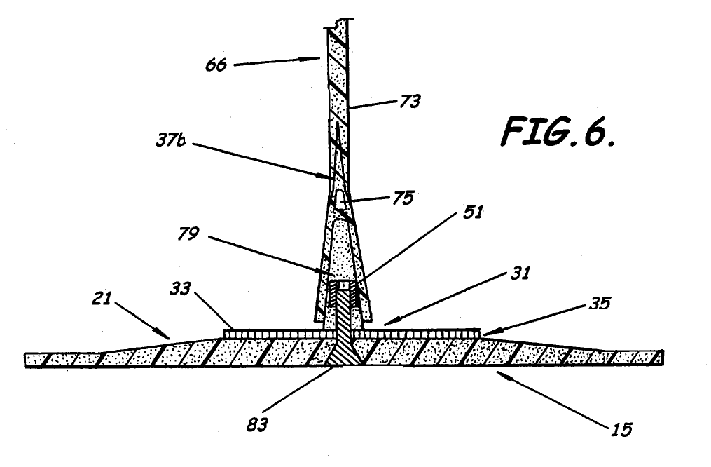

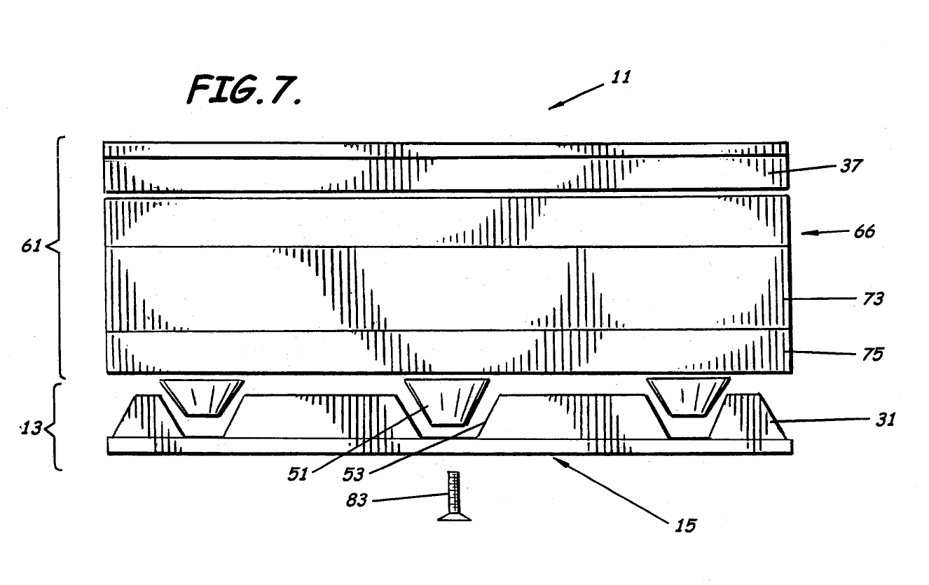

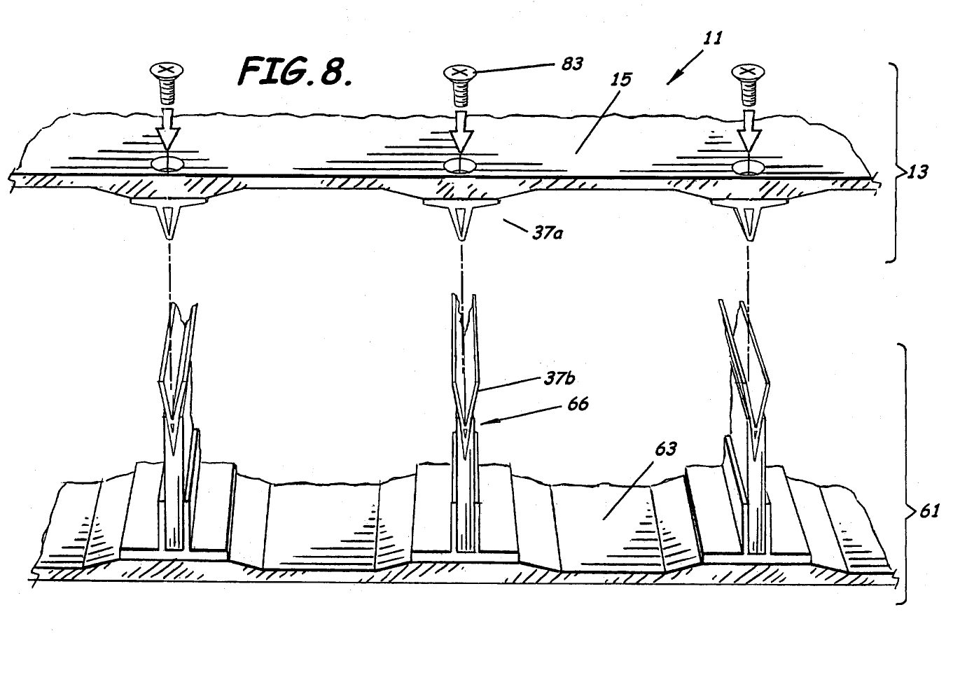

Each of the protrusions 31 also has a longitudinal profile (see FIG. 7), and a lateral cross-sectional shape (FIG. 5) that is transverse to the longitudinal profile. In addition, each protrusion 31 comprises a series of internal fasteners 51 (FIGS. 6 and 7) that are integrated into each of the protrusions 31. The internal fasteners 51 in each series of internal fasteners 51 are spaced apart from each other along respective ones of the longitudinal profiles (FIG. 7) of their respective protrusions 31. In one embodiment, each of the internal fasteners 51 comprises a nut element that is embedded in a respective protrusion 31.

In the embodiment shown, each of the protrusions 31 has a series of features or discontinuities 53. Each of the internal fasteners 51 is mounted in one of the discontinuities 53 and has a profile (e.g., trapezoidal) that is substantially complementary to said one of the discontinuities 53. The internal fasteners 51 also have a cross-sectional shape (FIG. 6) that is substantially consistent with the lateral cross-sectional shape of said respective one of the protrusions 31 such that the internal fasteners 51 are integrated into the protrusions 31, as shown. The internal fasteners 51 may be adhesively bonded to respective ones of the protrusions 31.

Again referring to FIGS. 3 and 4, the structural assembly 11 also includes a base assembly 61 that is secured to the closeout assembly 13, described above. Base assembly 61 has an external portion 63 or second structural member, and a plurality of spar webs 66 extending from the external portion 63. Like closeout assembly 13, the external portion 63 has a plurality of internal joint surfaces 67 located opposite an external surface 65. In one version, the external surface 65 is formed by a co-bonded laminated composite skin. The external portion 63 also has nominal regions 69 and each of the internal joint surfaces 67 is located on a built-up region 71. The nominal regions 69 have a thickness “t” that is less than a thickness “T” of the built-up regions 71.

In the embodiment shown, each of the spar webs 66 includes an unaltered pre-form 37 (FIG. 9) having a base 39 and a pair of legs 41 extending from the base 39, as described above. The unaltered pre-forms 37 are joined to the external portion 63 in the same manner that protrusions 31 are joined to the first structural member. A wall 73 is joined to and extends from pre-form 37 from in-between legs 41. From wall 73 extends a spar receptacle 75 which comprises another pre-form 37b (FIG. 11). Pre-forms 37b have base 39 with two lateral sides 77 and a pair of legs 41 extending from the base 39 between the two lateral sides 77. The pair of legs 41 are inclined toward each other to form a blade 43, and are located inside a respective one of the spar web walls 73. The two lateral sides 77 are folded away from the pair of legs 41 to form the spar receptacle 75 as a tapered trough having a Y-shaped lateral cross-section with internal surfaces 76.

Each of the spar receptacles 75 are complementary in shape to a respective one of the protrusions 31 and a series of internal fasteners 51 along a respective one of the longitudinal profiles (FIG. 7). The cross-sectional shape of the protrusions 31, internal fasteners 51, and spar receptacles 75 (FIG. 6) are also complementary. In this way, each spar receptacle 75 closely receives a respective one of the protrusions 31 and its series of internal fasteners 51. Moreover, each of the spar receptacles 75 is joined to respective ones of the protrusions 31 and its series of internal fasteners 51 with an adhesive 79. An embedded filler 81 is also used as needed between the spar receptacles 75 and protrusions 31/fasteners 51. When assembled the outer surfaces 45 of the blades 43 of protrusions 31 abut respective ones of the inner surfaces 76 to define interfaces that are wet by the adhesive 79. In this way, the spar webs 75 are substantially perpendicular to both external skins of the structural assembly 11.

The structural assembly 11 also includes a plurality of external fasteners 83 that extend through the external surface 15 of the closeout assembly 13. External fasteners 83 are connected to the internal fasteners 51 (FIG. 6) such that the external fasteners 83 are substantially flush with the external surface 15 of the closeout assembly 13. In one embodiment of the present invention, the external fasteners 83 comprise countersunk assembly pull-up or closeout fasteners, and may be adhesively bonded to the rest of the assembly when installed.

In operation, the present invention also comprises a method of forming the structure 11. The method comprises fabricating the closeout assembly 13 with a plurality of the protrusions 13. Each of the protrusions 13 has a longitudinal profile, a lateral cross-sectional shape that is transverse to the longitudinal profile, and a series of internal fasteners 51 integrated into each of the protrusions 31. The internal fasteners 51 in each series of internal fasteners are spaced apart from each other along respective ones of the longitudinal profiles. The method also includes providing the base assembly 61 with a plurality of the spar webs 66 extending from the external portion 63. Each of the spar webs 66 has a spar receptacle 75, and each of the spar receptacles 75 is complementary in shape to a respective one of the protrusions 33 and its series of internal fasteners 51 along a respective one of the longitudinal profiles.

The method joins each of the spar receptacles 75 to respective ones of the protrusions 31 and its series of internal fasteners 51 with an adhesive. A plurality of external fasteners 83 are extended through the closeout assembly 13 and connect the external fasteners 83 to respective ones of the internal fasteners 51 such that the external fasteners 83 are, in one embodiment, substantially flush with the external surface 15 of the closeout assembly 13.

The method further comprises forming a series of discontinuities 53 in each of the protrusions 31, and mounting the internal fasteners 51 in the discontinuities 53. The internal fasteners 51 have profiles that are substantially complementary to the discontinuities 53, and a cross-sectional shape that is substantially consistent with the lateral cross-sectional shape of the protrusions 31 such that the internal fasteners 51 are integrated into the protrusions 31.

The fabricating step of the method may comprise providing each of the protrusions 31 as a pre-form 37 having a planar base 39 and a pair of legs 41 extending from the base 39. The pair of legs 41 are inclined toward each other to form a wedge-like blade 43. The providing step may comprise providing each of the spar receptacles 75 as a pre-form 37 having a base 39 with two lateral sides 77 and a pair of legs 41 extending from the base 39 between the two lateral sides 77. The pair of legs 41 being inclined toward each other and located inside a respective one of the spar webs 66, and the two lateral sides 77 being folded away from the pair of legs 41 to form the spar receptacle 75 as a trough having a Y-shaped lateral cross-section. The method also may further comprise embedding a filler between each of the spar receptacles 75 and respective ones of the protrusions 31.

In addition, the fabricating step may comprise providing each of the protrusions 31 as a blade 43 having an elongated wedge-like shape with outer surfaces 45, and each of the spar receptacles 75 as a trough having a tapered Y-shaped cross-section with inner surfaces 76, wherein respective ones of the outer surfaces 77 abut respective ones of the inner surfaces 76 to define interfaces that are wet by the adhesive.

The tapered tension bond joint of the present invention has several advantages including the use of a system of composite and adhesive materials to provide a high strength, producible closeout joint for high performance structures. The system uses woven pre-form construction for mating parts, and a single part paste adhesive bonding material. The resultant tapered, secondarily bonded tension joint is typically stronger than the adjacent structure. The imbedded nuts serve as “internal tooling” to provide a positive stop for locating the lower skin, as well as a means for clamping the lower skin to the upper assembly during the closeout operation. The disruption of the blade of the closeout joint by the imbedded nuts gives the final assembled structure a very significantly enhanced ballistics survivability when impacted. Moreover, a very significant amount of tolerance is allowed for the fit between the blade and the slot, thereby reducing the cost associated with highly accurate 3-D joints. This “de-toleranced” design enables the ability of the mating joint to be effective for large differences in male to female joint interface location.

Additional advantages of the present invention include excellent high strength, especially with regard to high strain rates, hydrodynamic load attenuation, and ballistics survivability, thereby reducing the risk of catastrophic damage to the structure. The improvements of the present invention over the prior art provide an optimal load path for passing major shear loads through the center of the joint to the skin of the structure. The present design also significantly reduces the parts and fasteners required to complete construction, which greatly reduces the tooling requirements, assembly time, and cost for assembly.

While the invention has been shown or described in only some of its forms, it should be apparent to those skilled in the art that it is not so limited, but is susceptible to various changes without departing from the scope of the invention

1. A structural assembly, comprising:
a first structural member having a surface and a joint surface located opposite the surface;
a joint component having a base and a protrusion extending from the base, the base being mounted to and integrated with the joint surface of the first structural member, the protrusion having a longitudinal profile, a lateral cross-sectional shape that is transverse to the longitudinal profile, and a series of features formed in the protrusion, the features being spaced apart from each other along the longitudinal profile;
a plurality of internal fasteners, each of which is mounted in one of the features of the protrusion, each of the internal fasteners having a profile that is substantially complementary to a respective one of the features in the protrusion, and a cross-sectional shape that is substantially consistent with the lateral cross-sectional shape of the protrusion such that the internal fasteners are integrated into the protrusion;
a second structural member having a receptacle formed therein, the receptacle being complementary in shape to the protrusion and the internal fasteners along the longitudinal profile for receiving the protrusion and the internal fasteners, and the receptacle being joined to the protrusion and the internal fasteners with an adhesive; and
a plurality of external fasteners extending through the first structural member and connected to the internal fasteners such that the external fasteners are substantially flush with the surface of the first structural member.

2. The structural assembly of claim 1, wherein both the joint component and the receptacle of the second structural member are pre-forms having a base and a pair of legs extending from the base.

3. The structural assembly of claim 1, wherein the joint component is a pre-form and comprises a planar base and a pair of legs extending from the base, the pair of legs being inclined toward each other to form a wedge-like shape for the protrusion.

4. The structural assembly of claim 1, wherein the second structural member is a spar web and the receptacle comprises a pre-form having a base with two lateral sides and a pair of legs extending from the base between the two lateral sides, the pair of legs being inclined toward each other and located inside the spar web, and the two lateral sides being folded away from the pair of legs to form the receptacle as a trough having a Y-shaped lateral cross-section.

5. The structural assembly of claim 1, further comprising an embedded filler located between the receptacle and the protrusion.

6. The structural assembly of claim 1, wherein the protrusion is a blade having an elongated wedge-like shape with outer surfaces, and the receptacle is a trough having a tapered Y-shaped cross-section with inner surfaces, and wherein the outer surfaces abut the inner surfaces to define an interface that is wet by the adhesive.

7. The structural assembly of claim 1, wherein the first structural member is a closeout skin formed from a laminated composite, and the second structural member is a spar web that is substantially perpendicular to the closeout skin.

8. The structural assembly of claim 1, wherein the first structural member has a nominal region and the joint surface is located on a built-up region, such that the nominal region has a thickness that is less than a thickness of the built-up region.

9. The structural assembly of claim 8, wherein the joint component is joined to the first structural member with z-pins extending through the built-up region into the base of the joint component, and an adhesive is located between and bonds the base of the joint component and the built-up region.

10. The structural assembly of claim 1, wherein the internal fasteners are adhesively bonded to the protrusion at the features of the joint component.

11. A structural assembly, comprising in combination:
a closeout assembly having an external surface, a plurality of internal joint surfaces located opposite the external surface, and a plurality of protrusions, each of which extends from one of the internal joint surfaces, each of the protrusions having a longitudinal profile, a lateral cross-sectional shape that is transverse to the longitudinal profile, and a series of internal fasteners integrated into each of the protrusions such that the internal fasteners in each series of internal fasteners are spaced apart from each other along respective ones of the longitudinal profiles;
a base assembly having an external portion and a plurality of spar webs extending from the external portion, each of the spar webs having a spar receptacle, and each of the spar receptacles being complementary in shape to a respective one of the protrusions and said each series of internal fasteners along a respective one of the longitudinal profiles for receiving said respective one of the protrusions and said each series of internal fasteners, and each of the spar receptacles being joined to said respective one of the protrusions and said each series of internal fasteners with an adhesive; and
a plurality of external fasteners extending through the closeout assembly and connected to the internal fasteners such that the external fasteners are substantially flush with the external surface of the closeout assembly.

12. The structural assembly of claim 11, wherein each of the protrusions has a series of discontinuities, and each of the internal fasteners is mounted in one of the discontinuities and has a profile that is substantially complementary to said one of the discontinuities, and a cross-sectional shape that is substantially consistent with the lateral cross-sectional shape of said respective one of the protrusions such that the internal fasteners are integrated into the protrusions.

13. The structural assembly of claim 11, wherein each of protrusions comprises a pre-form having a planar base and a pair of legs extending from the base, the pair of legs being inclined toward each other to form a wedge-like blade.

14. The structural assembly of claim 11, wherein each of the spar receptacles comprises a pre-form having a base with two lateral sides and a pair of legs extending from the base between the two lateral sides, the pair of legs being inclined toward each other and located inside a respective one of the spar webs, and the two lateral sides being folded away from the pair of legs to form the spar receptacle as a trough having a Y-shaped lateral cross-section.

15. The structural assembly of claim 11, further comprising an embedded filler located between each of the spar receptacles and respective ones of the protrusions.

16. The structural assembly of claim 11, wherein each of the protrusions is a blade having an elongated wedge-like shape with outer surfaces, and each of the spar receptacles is a trough having a tapered Y-shaped cross-section with inner surfaces, and wherein respective ones of the outer surfaces abut respective ones of the inner surfaces to define interfaces that are wet by the adhesive.

17. The structural assembly of claim 11, wherein the closeout assembly includes a laminated composite skin, and the spar webs are substantially perpendicular to both the laminated composite skin and the external portion.

18. The structural assembly of claim 11, wherein the closeout assembly has nominal regions and each of the internal joint surfaces is located on a built-up region, such that the nominal regions have a thickness that is less than a thickness of the built-up regions.

19. The structural assembly of claim 18, wherein the protrusions are joined to the closeout assembly with z-pins extending through respective ones of the built-up regions, and an adhesive is located between and bonds respective ones of the protrusions and the built-up regions.

20. The structural assembly of claim 11, wherein the internal fasteners are adhesively bonded to respective ones of the protrusions, and the external fasteners are assembly pull-up fasteners.

21. A method of forming a structural assembly, comprising:
joining a protrusion to a first structural member, the protrusion having a longitudinal profile, a lateral cross-sectional shape that is transverse to the longitudinal profile, and a series of features formed in the protrusion, the features being spaced apart from each other along the longitudinal profile;
mounting an internal fastener in each one of the features of the protrusion, each of the internal fasteners having a profile that is substantially complementary to a respective one of the features in the protrusion, and a cross-sectional shape that is substantially consistent with the lateral cross-sectional shape of the protrusion such that the internal fasteners are integrated into the protrusion;
placing a second structural member on the protrusion and the internal fasteners, such that a receptacle formed in the second structural member engages the protrusion and the internal fasteners, the receptacle being complementary in shape to the protrusion and the internal fasteners along the longitudinal profile for receiving the protrusion and the internal fasteners;
bonding the receptacle to the protrusion and the internal fasteners with an adhesive; and then
extending external fasteners through the first structural member and into engagement with respective ones of the internal fasteners.

22. The method of claim 21, further comprising the step of pre-forming both the protrusion and the receptacle of the second structural member from an adhesive-impregnated laminate.

23. The method of claim 21, further comprising the steps of pre-forming the protrusion from an adhesive-impregnated laminate having a planar base and a pair of legs extending from the base, and folding the pair of legs inclined toward each other to form a wedge-like blade.

24. The method of claim 21, further comprising the steps of forming the second structural member as a spar web and the receptacle as a pre-form having a base with two lateral sides and a pair of legs extending from the base between the two lateral sides, folding the pair of legs toward each other and placing the pair of legs inside the spar web, and folding the two lateral sides away from the pair of legs to form the receptacle as a trough having a Y-shaped lateral cross-section.

25. The method of claim 21, further comprising the step of embedding a filler between the receptacle and the protrusion.

26. The method of claim 21, further comprising the steps of forming the protrusion as a blade having an elongated wedge-like shape with outer surfaces, forming the receptacle as a trough having a tapered Y-shaped cross-section with inner surfaces, and abutting the outer surfaces and the inner surfaces to define an interface that is wet by the adhesive.

27. The method of claim 21, further comprising the step of adhesively bonding the internal fasteners to the features in the protrusion.

28. A method of forming a structure, comprising:
fabricating a closeout assembly having a plurality of protrusions, each of the protrusions having a longitudinal profile, a lateral cross-sectional shape that is transverse to the longitudinal profile, and a series of internal fasteners integrated into each of the protrusions such that the internal fasteners in each series of internal fasteners are spaced apart from each other along respective ones of the longitudinal profiles;
providing a base assembly having a plurality of spar webs extending from the external portion, each of the spar webs having a spar receptacle, and each of the spar receptacles being complementary in shape to a respective one of the protrusions and said each series of internal fasteners along a respective one of the longitudinal profiles;
joining each of the spar receptacles to said respective one of the protrusions and said each series of internal fasteners with an adhesive; and
extending a plurality of external fasteners through the closeout assembly and connecting the external fasteners to respective ones of the internal fasteners such that the external fasteners are substantially flush with the external surface of the closeout assembly.

29. The method of claim 28, further comprising the steps of forming a series of discontinuities in each of the protrusions, mounting the internal fasteners in the discontinuities, wherein the internal fasteners have profiles that are substantially complementary to the discontinuities, and a cross-sectional shape that is substantially consistent with the lateral cross-sectional shape of the protrusions such that the internal fasteners are integrated into the protrusions.

30. The method of claim 28, wherein the fabricating step comprises providing each of the protrusions as a pre-form having a planar base and a pair of legs extending from the base, the pair of legs being inclined toward each other to form a wedge-like blade.

31. The method of claim 28, wherein the providing step comprises providing each of the spar receptacles as a pre-form having a base with two lateral sides and a pair of legs extending from the base between the two lateral sides, the pair of legs being inclined toward each other and located inside a respective one of the spar webs, and the two lateral sides being folded away from the pair of legs to form the spar receptacle as a trough having a Y-shaped lateral cross-section.

32. The method of claim 28, further comprising the step of embedding a filler between each of the spar receptacles and respective ones of the protrusions.

33. The method of claim 28, wherein the fabricating step comprises providing each of the protrusions as a blade having an elongated wedge-like shape with outer surfaces, and each of the spar receptacles as a trough having a tapered Y-shaped cross-section with inner surfaces, and wherein respective ones of the outer surfaces abut respective ones of the inner surfaces to define interfaces that are wet by the adhesive.
